(19) United States
(12) Patent Application Publication
(10) Pub. No.: US 2021/0042501 A1
(43) Pub. Date: Feb. 11, 2021

(54) METHOD AND DEVICE FOR PROCESSING POINT CLOUD DATA, ELECTRONIC DEVICE AND STORAGE MEDIUM

(71) Applicant: BEIJING SENSETIME TECHNOLOGY DEVELOPMENT CO., LTD., Beijing (CN)

(72) Inventors: Jiageng MAO, Beijing (CN); Xiaogang WANG, Beijing (CN); Hongsheng LI, Beijing (CN)

(21) Appl. No.: 17/082,686

(22) Filed: Oct. 28, 2020

Related U.S. Application Data
(63) Continuation of application No. PCT/CN2019/121776, filed on Nov. 28, 2019.

(30) Foreign Application Priority Data
May 22, 2019 (CN) 201910430700.7

(51) Int. Cl. G06K 9/00; G06K 9/62; G06K 9/72; G06K 9/46; G06K 9/54

(52) U.S. Cl. CPC G06K 9/00201; G06K 9/6267; G06K 9/726; G06K 9/00362; G06K 9/54; G06K 2209/23; G06K 9/468

(57) ABSTRACT

A method for processing point cloud data includes: point cloud data in a target scene and weight vectors of a first discrete convolution kernel are obtained; interpolation processing is performed on the point cloud data based on the point cloud data and the weight vectors of the first discrete convolution kernel to obtain first weight data, the first weight data representing weights of allocation of the point cloud data to positions corresponding to the weight vectors of the first discrete convolution kernel; first discrete convolution processing is performed on the point cloud data based on the first weight data and the weight vectors of the first discrete convolution kernel to obtain a first discrete convolution result; and a spatial structure feature of at least part of point cloud data in the point cloud data is obtained based on the first discrete convolution result.

### CROSS-REFERENCE TO RELATED APPLICATIONS

This application is a continuation of International Application No. PCT/CN2019/121776, filed on Nov. 28, 2019, which claims priority to Chinese Patent Application No. 201910430700.7, filed on May 22, 2019. The disclosures of International Application No. PCT/CN2019/121776 and Chinese Patent Application No. 201910430700.7 are hereby incorporated by reference in their entireties.

### BACKGROUND

Point cloud recognition is an important issue in the fields of computer vision and deep learning. a three-dimensional structure of an object is recognized through learning point cloud data.

### SUMMARY

The disclosure relates to the technical field of computer application, and particularly to a method and device for processing point cloud data, an electronic device and a computer-readable storage medium.

For solving existing technical problems, embodiments of the disclosure provide a method and device for processing point cloud data, and an electronic device.

To this end, the technical solutions of the embodiments of the disclosure are implemented as follows.

The embodiments of the disclosure provide a method for processing point cloud data, which may include the following operations.

Point cloud data in a target scene and weight vectors of a first discrete convolution kernel are obtained. Interpolation processing is performed on the point cloud data based on the point cloud data and the weight vectors of the first discrete convolution kernel to obtain first weight data, the first weight data representing weights of allocation of the point cloud data to positions corresponding to the weight vectors of the first discrete convolution kernel. First discrete convolution processing is performed on the point cloud data based on the first weight data and the weight vectors of the first discrete convolution kernel to obtain a first discrete convolution result. A spatial structure feature of at least part of point cloud data in the point cloud data is obtained based on the first discrete convolution result.

The embodiments of the disclosure also provide a device for processing point cloud data, which may include a memory storing processor-executable instructions; and a processor configured to execute the stored processor-executable instructions to perform operations of: obtaining point cloud data in a target scene and weight vectors of a first discrete convolution kernel; performing interpolation processing on the point cloud data based on the point cloud data and the weight vectors of the first discrete convolution kernel to obtain first weight data, the first weight data representing weights of allocation of the point cloud data to positions corresponding to the weight vectors of the first discrete convolution kernel; and performing first discrete convolution processing on the point cloud data based on the first weight data and the weight vectors of the first discrete convolution kernel to obtain a first discrete convolution result and obtain a spatial structure feature of at least part of point cloud data in the point cloud data based on the first discrete convolution result.

The embodiments of the disclosure also provide a non-transitory computer-readable storage medium having stored thereon computer-readable instructions that, when executed by a processor, cause the processor to perform a method for processing point cloud data, the method including: obtaining point cloud data in a target scene and weight vectors of a first discrete convolution kernel; performing interpolation processing on the point cloud data based on the point cloud data and the weight vectors of the first discrete convolution kernel to obtain first weight data, the first weight data representing weights of allocation of the point cloud data to positions corresponding to the weight vectors of the first discrete convolution kernel; and performing first discrete convolution processing on the point cloud data based on the first weight data and the weight vectors of the first discrete convolution kernel to obtain a first discrete convolution result and obtain a spatial structure feature of at least part of point cloud data in the point cloud data based on the first discrete convolution result.

### BRIEF DESCRIPTION OF THE DRAWINGS

FIG. 1 is a first flowchart of a method for processing point cloud data according to an embodiment of the disclosure.

FIG. 2A and FIG. 2B are schematic diagrams of interpolation processing in a point cloud processing method according to an embodiment of the disclosure respectively.

FIG. 3 is a second flowchart of a method for processing point cloud data according to an embodiment of the disclosure.

FIG. 4 is a network structure of a first network in a method for processing point cloud data according to an embodiment of the disclosure.

FIG. 5 is a third flowchart of a method for processing point cloud data according to an embodiment of the disclosure.

FIG. 6 is a network structure of a second network in a method for processing point cloud data according to an embodiment of the disclosure.

FIG. 7 is a first composition structure diagram of a device for processing point cloud data according to an embodiment of the disclosure.

FIG. 8 is a second composition structure diagram of a device for processing point cloud data according to an embodiment of the disclosure.

FIG. 9 is a third composition structure diagram of a device for processing point cloud data according to an embodiment of the disclosure.

FIG. 10 is a composition structure diagram of an electronic device according to an embodiment of the disclosure.

### DETAILED DESCRIPTION

The disclosure will further be described below in combination with the drawings and specific embodiments in detail.

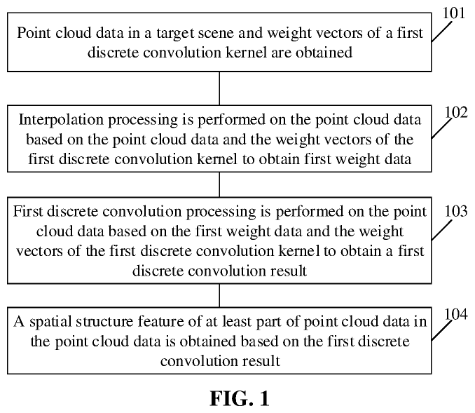

The embodiments of the disclosure provide a method for processing point cloud data. FIG. 1 is a first flowchart of a method for processing point cloud data according to an embodiment of the disclosure. As shown in FIG. 1, the method includes the following operations.

In operation 101, point cloud data in a target scene and weight vectors of a first discrete convolution kernel are obtained.

In operation 102, interpolation processing is performed on the point cloud data based on the point cloud data and the weight vectors of the first discrete convolution kernel to obtain first weight data, the first weight data representing weights of allocation of the point cloud data to positions corresponding to the weight vectors of the first discrete convolution kernel.

In operation 103, first discrete convolution processing is performed on the point cloud data based on the first weight data and the weight vectors of the first discrete convolution kernel to obtain a first discrete convolution result.

In operation 104, a spatial structure feature of at least part of point cloud data in the point cloud data is obtained based on the first discrete convolution result.

In the embodiment, the point cloud data refers to a point data set, obtained by a measurement device, of an appearance surface of an object in the target scene, a set of massive points representing surface properties of the object in the target scene. The point cloud data includes three-dimensional coordinate data of each point. During a practical application, as an implementation mode, the point cloud data may be represented by an N*3 matrix vector, where N represents the number of the points in the point cloud data, and a three-dimensional coordinate of each point may be represented by a 1*3 feature vector. In another implementation mode, besides including the three-dimensional coordinate data of each point, the point cloud data may further include color information, for example, including data of colors red, green and blue (called Red Green Blue (RGB) data for short). In such case, the point cloud data may be represented by an N*6 matrix, and data of each point may be represented by a 1*6 matrix, the data of three dimensions being configured to represent the three-dimensional coordinate of the point and the data of the other three dimensions being configured to represent the data of the three colors.

The point cloud data further includes description information, the description information may be represented by a feature of each point in the point cloud data, and the feature of each point in the point cloud data may include a normal direction, a curvature and the like. During the practical application, the description information may also be represented by a feature vector including a feature of the point cloud data. It can be understood that the point cloud data includes position information and feature vector corresponding to the point cloud data.

In the embodiment, weight vectors of discrete convolution kernels (including the weight vectors of the first discrete convolution kernel in the embodiment and weight vectors of a second discrete convolution kernel and weight vectors of a third discrete convolution kernel in subsequent embodiments) are weight vectors of three-dimensional discrete convolution kernels. It can be understood that the three-dimensional convolution kernel corresponds to a cubic region in a discrete convolution processing process and eight vertexes of the cubic region correspond to the weight vectors of the discrete convolution kernel (the weight vectors of the first discrete convolution kernel in the embodiment). It can be understood that the weight vector of the discrete convolution kernel in the embodiment does not refer to one weight vector but refers to at least eight weight vectors and the eight weight vectors may be weight vectors of the same discrete convolution kernel and may also be weight vectors of multiple different discrete convolution kernels.

In the embodiment, the weight vector of the discrete convolution kernel corresponds to a convolution parameter, and the convolution parameter may include a kernel size and length. The kernel size and length determine a size range of a convolution operation, namely determining a size or side length of the cubic region.

In the embodiment, each point in the point cloud data is discretely distributed. Therefore, for ensuring that spatial structure information of the point cloud data is fully recognized, in the embodiment, interpolation processing is performed on the point cloud data through the technical solution recorded in operation 102 at first to establish associations between the point cloud data and the weight vectors of the first discrete convolution kernel. In such a manner, the point cloud data may be aligned with the positions where the weight vectors of the first discrete convolution kernel are located, and the spatial structure feature of the point cloud data may be captured better in the discrete convolution processing process.

In an optional embodiment of the disclosure, for operation 102, the operation that interpolation processing is performed on the point cloud data based on the point cloud data and the weight vectors of the first discrete convolution kernel to obtain the first weight data includes that: the first weight data is obtained through a preset interpolation processing manner based on the point cloud data and the weight vectors of the first discrete convolution kernel, the first weight data representing the weights of allocation of the point cloud data to the positions corresponding to the weight vectors of the first discrete convolution kernel that meet a preset condition, where the point cloud data is in a specific geometrically shaped region enclosed by the weight vectors of the first discrete convolution kernel that meet the preset condition.

In the embodiment, interpolation processing may be performed on the point cloud data in different preset interpolation processing manners. Interpolation processing may be implemented through an interpolation function, namely interpolation processing may be performed on the point cloud data through different interpolation functions. For example, the interpolation processing manner may be a trilinear interpolation processing manner or a Gaussian interpolation processing manner, namely interpolation processing may be performed on the point cloud data through a trilinear interpolation function or a Gaussian function. During the practical application, the weight vector of the discrete convolution kernel (the weight vector of the first discrete convolution kernel in the embodiment) and the point cloud data (specifically a coordinate of the point cloud data) may be input to the interpolation function to obtain the first weight data.

In the embodiment, for different interpolation processing manners, the weight vectors of the first discrete convolution kernel that correspond to the same point cloud data and meet the preset condition are different, and specific geometrically shaped regions are also different. The weight vectors of the first discrete convolution kernel that meet the preset condition are weight vectors of the discrete convolution kernel that enclose the specific geometrically shaped region where the point cloud data is located.

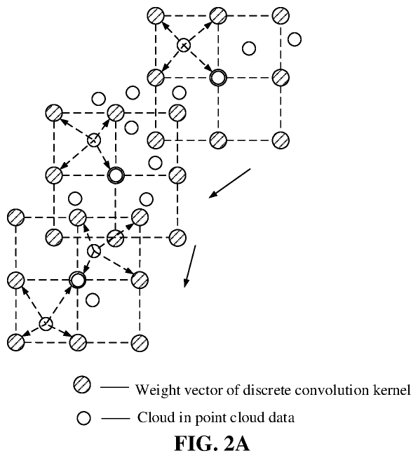

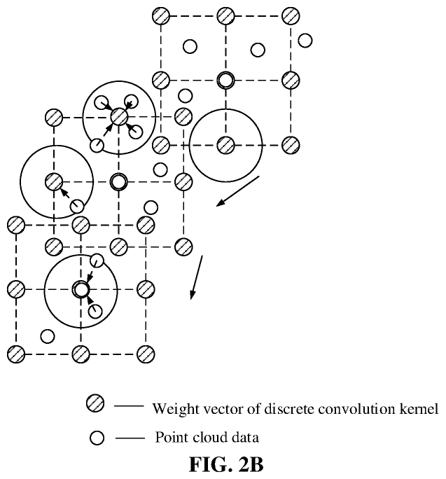

FIG. 2A and FIG. 2B are schematic diagrams of interpolation processing in a method for processing point cloud data according to an embodiment of the disclosure respectively. As an implementation mode, as shown in FIG. 2A, in the case of the interpolation processing manner being the trilinear interpolation processing manner, a specific geometrically shaped region is a cubic region corresponding to a discrete convolution kernel, i.e., a cubic region formed by eight weight vectors (the weight vectors of the first discrete convolution kernel in the embodiment), and eight vertexes of the cubic region correspond to the eight weight vectors respectively. The eight weight vectors corresponding to the eight vertexes of each cubic region may belong to the same discrete convolution kernel and may also belong to multiple different discrete convolution kernels. Therefore, if a point is in a certain cubic region, the weight vectors of the first discrete convolution kernel that meet the preset condition are weight vectors corresponding to eight vertexes of the cubic region where the point is located, as shown in FIG. 2A. Correspondingly, the first weight data obtained by processing the point cloud data in the trilinear interpolation manner represents weights of allocation of the point cloud data to position corresponding to each weight vector in the eight weight vectors corresponding to the corresponding cubic region.

As another implementation mode, as shown in FIG. 2B, in the case of the interpolation processing manner being the Gaussian interpolation processing manner, a specific geometrically shaped region is a spherical region taking a weight vector of a discrete convolution kernel (a weight vector of the first discrete convolution kernel in the embodiment) as a sphere center and taking a preset length as a radius. Radii of spherical regions corresponding to weight vectors of different discrete convolution kernels may be the same or different. It can be understood that, during the practical application, the point cloud data may be located in one, two or more than two or zero spherical region, specifically as shown in FIG. 2B. The first weight data obtained by processing the point cloud data in the Gaussian interpolation manner represents a weight of allocation of the point cloud data to the sphere center (i.e., a certain weight vector of the first discrete convolution kernel) of the spherical region where the point cloud data is located.

It can be understood that a piece of point cloud data may be associated with eight weight vectors of a discrete convolution kernel, like a scene shown in FIG. 2A, may also be associated with part of weight vectors of a discrete convolution kernel (for example, a weight vector of the first discrete convolution kernel), like a scene shown in FIG. 2B, and may also be associated with part of weight vectors of each discrete convolution kernel in multiple discrete convolution kernels. For example, in the Gaussian interpolation processing manner, a radius of each spherical region is relatively large such that the point cloud data is in spherical regions corresponding to weight vectors of multiple different discrete convolution kernels.

In an optional embodiment of the disclosure, for operation 103, under a normal condition, discrete convolution processing refers to a processing manner of multiplying related sequences of two discrete sequences pairwise for addition according to a predetermined rule. In the embodiment, discrete convolution processing is performed on the point cloud data based on the first weight data and the weight vectors of the first discrete convolution kernel, which is equivalent to adopting a weighted discrete convolution processing manner in the embodiment, namely each multiplication result of pairwise multiplication processing of the related sequences is multiplied by the first weight data. In the embodiment, pairwise multiplication processing is performed on the weight vectors of the first discrete convolution kernel and the feature vectors of the point cloud data, every pairwise multiplication result is multiplied by the first weight data and then products are added.

In an optional embodiment of the disclosure, for operation 103, after the operation that the first discrete convolution result is obtained, the method further includes that: normalization processing is performed on the first discrete convolution result based on a normalization parameter, the normalization parameter being determined according to an amount of the point cloud data in the specific geometrically shaped region where the point cloud data is located. As an example, if the trilinear interpolation processing manner is adopted, the amount of the point cloud data in a certain cubic region shown in FIG. 2A is 4, and in such case, after discrete convolution processing is performed on each piece of point cloud data in the four pieces of point cloud data to obtain a first discrete convolution result, normalization processing is performed on the first discrete convolution result based on the numerical value 4. As another example, if the Gaussian interpolation processing manner is adopted, the amount of the point cloud data in a certain spherical region shown in FIG. 2B is 2, and in such case, after discrete convolution processing is performed on each piece of point cloud data in the four pieces of point cloud data to obtain a first discrete convolution result, normalization processing is performed on the first discrete convolution result based on the numerical value 2.

As an implementation mode, first discrete convolution processing and normalization processing may be implemented with reference to the following expression (1):

$$F * W ( \hat{p} ) = {\sum }_{{p}^{′}} \frac{1}{{N}_{{p}^{′}}} {\sum }_{{p}_{δ}} T ( {p}_{δ} , {p}^{′} ) W ( {p}^{′} ) \cdot F ( \hat{p} + {p}_{δ} ) . \qquad ( 1 )$$

F*W(\hat{p}) represents an output discrete convolution result obtained by normalization processing (i.e., the first discrete convolution result obtained by normalization processing in the embodiment), \hat{p} represents an output point cloud position, N_{p′} represents an amount of the point cloud data in the specific geometrically shaped region, p′ represents the position corresponding to the weight vector of the discrete convolution kernel (i.e., the weight vector of the first discrete convolution kernel in the embodiment), p_{δ} represents a position corresponding to the point cloud data, T(p_{δ},p′) represents weight data (i.e., the first weight data in the embodiment) determined based on the position corresponding to the weight vector of the discrete convolution kernel (i.e., the weight vector of the first discrete convolution kernel in the embodiment), the position corresponding to the point cloud data and the interpolation function T, W(p′) represents the weight vector of the discrete convolution kernel (i.e., the weight vector of the first discrete convolution kernel in the embodiment), and F(\hat{p}+p_{δ}) represents the feature vector of the point cloud data in the specific geometrically shaped region.

In the embodiment, in operation 103, the operation that first discrete convolution processing is performed on the point cloud data based on the first weight data and the weight vectors of the first discrete convolution kernel is implemented as follows: after the point cloud data is allocated to the positions corresponding to the weight vectors of the first discrete convolution kernel that meet the preset condition, discrete convolution processing is performed on the point cloud data through the weight vectors of the first discrete convolution kernel, thereby obtaining a feature vector representing the spatial structure feature of the point cloud data, namely obtaining the first discrete convolution result.

In combination with applications, a spatial structure feature of point cloud data may be recognized through a neural network based on different tasks of the neural network to further determine a category of an object in a target scene, the category of the object being, for example, a vehicle and a person, and the category of the object in the target scene may be directly output through the neural network. Or, a spatial structure feature of at least one point in the point cloud data may be recognized through the neural network to further determine semantic information of the at least one point in the point cloud data. The semantic information of the point data may represent a category of the point data, and the category of the point data represents object information of the point data. For example, if the target scene includes multiple objects such as a person and a vehicle, whether the object corresponding to the point data in the point cloud data is the person or the vehicle may be determined by recognition based on the semantic information of the point data, and all point data corresponding to the person and all point data corresponding to the vehicle may be determined by recognition based on the semantic information of the point data.

In the embodiment, in 104, first discrete convolution processing is performed on the point cloud data for a purpose of increasing a difference between the point data in the point cloud data and other point data, thereby obtaining the spatial structure feature of at least part of point cloud data in the point cloud data. The spatial structure feature represents a feature of the point cloud data in a three-dimensional space scene. The feature of the point cloud data may include the normal direction, the curvature and the like. Determination of the spatial structure feature of at least part of point cloud data in the point cloud data, specifically determination by combining the feature such as the normal direction, curvature and the like of the point cloud data and the position of the point cloud data, provides a basis for subsequently determining the object in the target scene and the category of the object or determining the semantic information of at least one point in the point cloud data.

Based on this, the technical solution of the embodiment is applied to the fields of virtual reality, augmented reality, medicine, aviation, intelligent drive, robots and the like. For example, in the field of intelligent drive, point cloud data of a scene in front of a running vehicle is collected, and the point cloud data is recognized in the processing manner in the embodiment to determine an object that each point belongs to in the point cloud data, thereby semantically separating each point. Or, categories of the objects in the scene corresponding to the point cloud data may also be determined, thereby recognizing whether the scene in front of the running vehicle includes another vehicle or includes a pedestrian to provide basic data for an operation to be executed subsequently by the running vehicle.

With adoption of the technical solution of the embodiment of the disclosure, interpolation processing is performed on the point cloud data to establish an association between the point cloud data and the first discrete convolution kernel, namely obtaining the weights of allocation of the point cloud data to the positions corresponding to the weight vectors of the first discrete convolution kernel, thereby aligning the discrete point cloud data and the weight vectors of the discrete convolution kernel and explicitly defining a geometrical relationship between the point cloud data and the first discrete convolution kernel to capture the spatial structure feature of the point cloud data better in a discrete convolution processing process.

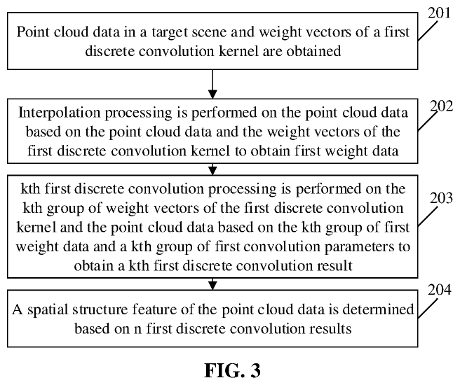

The embodiments of the disclosure also provide a method for processing point cloud data. FIG. 3 is a second flowchart of a method for processing point cloud data according to an embodiment of the disclosure. As shown in FIG. 3, the method includes the following operations.

In operation 201, point cloud data in a target scene and weight vectors of a first discrete convolution kernel are obtained.

In operation 202, interpolation processing is performed on the point cloud data based on the point cloud data and the weight vectors of the first discrete convolution kernel to obtain first weight data, the first weight data representing weights of allocation of the point cloud data to positions corresponding to the weight vectors of the first discrete convolution kernel, there being n groups of weight vectors of the first discrete convolution kernel and n groups of first weight data, where n is an integer more than or equal to 2.

In operation 203, kth first discrete convolution processing is performed on the kth group of weight vectors of the first discrete convolution kernel and the point cloud data based on the kth group of first weight data and a kth group of first convolution parameters to obtain a kth first discrete convolution result, the kth group of first convolution parameters corresponding to a size range of kth first discrete convolution processing, where k is an integer more than or equal to 1 and less than or equal to n.

In operation 204, a spatial structure feature of the point cloud data is determined based on n first discrete convolution results.

In the embodiment, detailed descriptions about operations 201 to 202 may specifically refer to the detailed descriptions about operations 101 to 102 in the abovementioned embodiment, and elaborations are omitted herein. Similarly, detailed descriptions about interpolation processing and discrete convolution processing in each operation of the embodiment may specifically refer to the detailed descriptions about operations 102 to 103 in the abovementioned embodiment, and elaborations are omitted herein.

In an optional embodiment of the disclosure, for operation 202, there are n groups of weight vectors of the first discrete convolution kernel, and in such case, the operation that interpolation processing is performed on the point cloud data based on the point cloud data and the weight vectors of the first discrete convolution kernel to obtain the first weight data includes that: interpolation processing is performed on the point cloud data based on the point cloud data and the kth group of weight vectors of the first discrete convolution kernel to obtain the kth group of first weight data respectively, where k is an integer more than or equal to 1 and less than or equal to n, and n is an integer more than or equal to 2. During a practical application, there may be n groups of weight vectors of the first discrete convolution kernel, and the point cloud data and the kth group of weight vectors of the first discrete convolution kernel in the n groups of weight vectors of the first discrete convolution kernel are input to an interpolation function to obtain the kth group of first weight data respectively. That is, the point cloud data and the n groups of weight vectors of the first discrete convolution kernel may be input to the interpolation function to obtain the n groups of first weight data respectively.

In the embodiment, a three-dimensional discrete convolution kernel corresponds to a cubic region in a discrete convolution processing process, and eight vertexes of the cubic region correspond to eight weight vectors (recorded as the weight vectors of the first discrete convolution kernel). Each three-dimensional discrete convolution kernel corresponds to a convolution parameter, namely the weight vector of the first discrete convolution kernel corresponding to the three-dimensional discrete convolution kernel corresponds to a convolution parameter, and the convolution parameter may include a kernel size and length. The kernel size and length determine a size range of a convolution operation, namely determining a size or side length of the cubic region.

In the embodiment, for the point cloud data, kth first discrete convolution processing is performed on the kth group of weight vectors of the first discrete convolution kernel and the point cloud data by use of the kth group of first weight data and the kth group of first convolution parameters to obtain the kth first discrete convolution result, and a specific first discrete convolution processing process may refer to the descriptions in the abovementioned embodiment and will not be elaborated herein. During the practical application, interpolation processing and discrete convolution processing in the embodiment may be implemented through interpolation discrete convolution layers in a network. It can be understood that, in the embodiment, interpolation processing and discrete convolution processing are performed on the same point cloud data through n interpolation discrete convolution layers, thereby obtaining the n first discrete convolution results.

The kth group of first convolution parameters correspond to a size range of kth first discrete convolution processing. That is, size ranges of discrete convolution processing corresponding to at least part of first convolution parameters in the n groups of first convolution parameters are different. It can be understood that, if the first convolution parameter is greater, the size range of discrete convolution processing is larger and a receptive field is larger, and correspondingly, if the first convolution parameter is smaller, the size range of discrete convolution processing is smaller and the receptive field is smaller. In the embodiment, discrete convolution processing may be performed on the point cloud data through a group of weight vectors of the first discrete convolution kernel that correspond to relatively small first convolution parameters to obtain a fine surface spatial structure feature of a target object, and discrete convolution processing may be performed on the point cloud data through a group of weight vectors of the first discrete convolution kernel that correspond to relatively great first convolution parameters to obtain a spatial structure feature of a background. It can be understood that the network including the n discrete convolution layers in the embodiment may perform interpolation processing and discrete convolution processing on the point cloud data through the kth group of weight vectors of the first discrete convolution kernel in the n groups of weight vectors of the first discrete convolution kernel and the corresponding kth group of first convolution parameters. The network is a neural network with multiple receptive fields, may capture the fine surface spatial structure feature of the point cloud data and the spatial structure feature of background information to facilitate subsequent determination of a category of the point cloud data, i.e., a category of an object in the target scene (i.e., classification task) and may improve the accuracy of the classification task.

In the implementation mode, interpolation processing and discrete convolution processing are concurrently performed once for the point cloud data based on the n groups of weight vectors of the first discrete convolution kernel and the n groups of first convolution parameters, and the spatial structure feature of the point cloud data is determined based on the n obtained first discrete convolution results. In another implementation mode, for recognizing the spatial structure feature of the point cloud data better, interpolation processing and discrete convolution processing may be sequentially performed for many times, and in each interpolation processing and discrete convolution processing process, interpolation processing and discrete convolution processing may be concurrently performed based on multiple groups of weight vectors of the first discrete convolution kernel and multiple groups of first convolution parameters.

In an optional embodiment of the disclosure, the operation that the spatial structure feature of the point cloud data is determined based on the n first discrete convolution results includes that: interpolation processing is performed on first processing data based on the first processing data and weight vectors of a second discrete convolution kernel to obtain second weight data, the second weight data representing weights of allocation of the first processing data to positions corresponding to the weight vectors of the second discrete convolution, the first processing data being determined according to a previous discrete convolution processing result and the first processing data being determined according to the n first discrete convolution results in the case of the previous discrete convolution processing result including the n first discrete convolution results; second discrete convolution processing is performed on the first processing data based on the second weight data and the weight vectors of the second discrete convolution kernel to obtain a second discrete convolution result; and the spatial structure feature of the point cloud data is obtained based on the second discrete convolution result.

As an implementation mode, the n first discrete convolution results are integrated to obtain the first processing data in the embodiment. During the practical application, weighted summation processing may be performed on data of a corresponding channel in each first discrete convolution result in the n first discrete convolution results to obtain the first processing data. Furthermore, interpolation processing is performed on the first processing data by use of the weight vectors of the second discrete convolution kernel, and discrete convolution processing is performed on the first data based on the weight vectors of the second discrete convolution kernel and the second weight data to obtain the second discrete convolution result. Specific implementation manners of interpolation processing and discrete convolution processing are the same as those in the abovementioned embodiment and will not be elaborated herein. In another implementation mode, the first processing data may be determined according to the previous discrete convolution processing result. A determination manner for the first processing data is similar to that in the abovementioned implementation mode and will not be elaborated herein.

In the embodiment, there are l groups of weight vectors of the second discrete convolution kernel and l groups of second weight data, where l is an integer more than or equal to 2. The operation that discrete convolution processing is performed on the first processing data based on the second weight data and the weight vectors of the second discrete convolution kernel includes that: mth second discrete convolution processing is performed on the mth group of weight vectors of the second discrete convolution kernel and the first processing data based on the mth group of second weight data and an mth group of second convolution parameters to obtain an mth second discrete convolution result, the mth group of second convolution parameters corresponding to a size range of mth discrete convolution processing, where m is an integer more than or equal to 1 and less than or equal to l. The operation that the spatial structure feature of the point cloud data is obtained based on the second discrete convolution result includes that: the spatial structure feature of the point cloud data is determined based on l second discrete convolution results, a numerical value of l being the same as or different from a numerical value of n.

It can be understood that, for example, if interpolation processing and discrete convolution processing are sequentially performed twice on the point cloud data, the n first discrete convolution results are obtained at first by performing interpolation processing on the point cloud data through the kth group of weight vectors of the first discrete convolution kernel in the n groups of weight vectors of the first discrete convolution kernel respectively and performing discrete convolution processing through the kth group of weight vectors of the first discrete convolution kernel in the n groups of weight vectors of the first discrete convolution kernel and the kth group of first convolution parameters in the n groups of first convolution parameters, then the n first discrete convolution results are integrated to the first processing data, interpolation processing is performed through the mth group of weight vectors of the second discrete convolution kernel in the l groups of weight vectors of the second discrete convolution kernel, discrete convolution processing is performed through the mth group of weight vectors of the second discrete convolution kernel in the l groups of weight vectors of the second discrete convolution kernel and the mth group of second convolution parameters in the l groups of second convolution parameters to obtain the l second discrete convolution results, and the spatial structure feature of the point cloud data is determined based on the l second discrete convolution results. That is, the point cloud data in the embodiment is subjected to an interpolation-discrete convolution-interpolation-discrete convolution processing process, and interpolation processing and discrete convolution processing are performed on the point cloud data through multiple paths in each interpolation processing and discrete convolution processing process respectively. During the practical application, the number processing cycles may be determined based on a practical condition, and may be, for example, three.

Detailed descriptions will be made below in combination with a specific network structure.

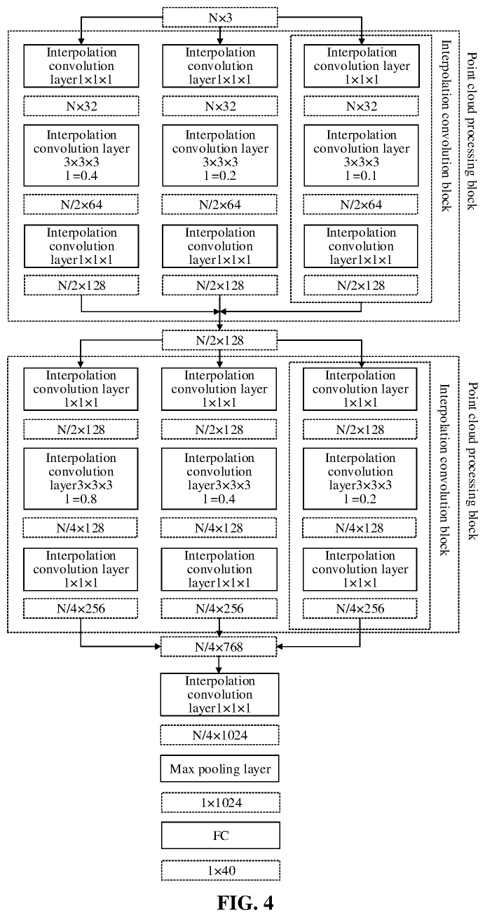

FIG. 4 is a structure diagram of a first network in a method for processing point cloud data according to an embodiment of the disclosure. Descriptions are made with inclusion of three groups of interpolation convolution layers as an example. Each group of interpolation convolution layers may perform interpolation processing and discrete convolution processing on input data, namely each group of interpolation convolution layers may execute the interpolation processing and discrete convolution processing process in the embodiment. As shown in FIG. 4, the point cloud data is input to three interpolation convolution blocks (InterpConv Blocks) for interpolation processing and discrete convolution processing respectively. Each interpolation convolution block includes three interpolation convolution layers, sequentially including a 1*1*1 interpolation convolution layer (InterpConv), a 3*3*3 interpolation convolution layer and a 1*1*1 interpolation convolution layer, the 1*1*1 interpolation convolution layer being configured to regulate a channel. The 3*3*3 interpolation convolution layers in different interpolation convolution blocks correspond to different convolution parameters. For example, the convolution parameter corresponding to the 3*3*3 interpolation convolution layer in the first interpolation convolution block is 1=0.4, the convolution parameter corresponding to the 3*3*3 interpolation convolution layer in the second interpolation convolution block is 1=0.2, and the convolution parameter corresponding to the 3*3*3 interpolation convolution layer in the third interpolation convolution block is 1=0.1. In the example, the convolution parameter 1 represents a kernel length. As an example, the double of the kernel length (kernel length*2) may represent a side length of a cube formed by eight weight vectors in FIG. 2.

In the example, the input point cloud data is represented by an N*3 matrix vector. Data obtained after interpolation convolution processing is performed on the point cloud data through the 1*1*1 interpolation convolution layers of three paths respectively is 32-channel data, recorded as N*32. The 32-channel data (i.e., N*32) is input to the 3*3*3 interpolation convolution layers respectively, and obtained data is 64-channel data subsampled to ½ of the original data, recorded a N/2*64. Then, the 64-channel data (N/2*64) subsampled to ½ of the original data is input to the 1*1*1 interpolation convolution layers, and interpolation convolution processing is performed to obtain 128-channel data subsampled to ½ of the original data, recorded as N/2*128. Such a process may be recorded as a processing process in a point cloud processing block, and the point cloud processing block may include three interpolation convolution blocks (InterpConv Blocks). In the example, interpolation convolution processing may be repeatedly performed on the point cloud data through at least two point cloud processing blocks. As shown in FIG. 4, interpolation convolution processing is performed on the point cloud data through two point cloud processing blocks. The numbers of interpolation convolution blocks in each point cloud processing block may be the same and may also be different. In the example, the numbers of the interpolation convolution blocks in the two point cloud processing blocks are the same, both three. After three pieces of N/2*128 data are integrated, integrated N/2*128 data is processed again through three interpolation convolution blocks in a point cloud processing block, and a processing process is similar to the processing process of the first point cloud processing block. A difference is that convolution parameters corresponding to the interpolation convolution blocks in the second point cloud processing block may be different from convolution parameters corresponding to the interpolation convolution blocks in the first point cloud processing block and the convolution parameters corresponding to the interpolation convolution blocks in the second point cloud processing block are greater than the convolution parameters corresponding to the interpolation convolution blocks in the first point cloud processing block. For example, the convolution parameter corresponding to a 3*3*3 interpolation convolution layer in the first interpolation convolution block in the second point cloud processing block is 1=0.8, and the convolution parameter corresponding to a 3*3*3 interpolation convolution layer in the first interpolation convolution block in the first point cloud block is 1=0.4; and the convolution parameter corresponding to a 3*3*3 interpolation convolution layer in the second interpolation convolution block in the second point cloud processing block is 1=0.4, and the convolution parameter corresponding to a 3*3*3 interpolation convolution layer in the second interpolation convolution block in the first point cloud block is 1=0.2. It can be understood that, in the embodiment, in the process of repeatedly performing interpolation processing and discrete convolution processing on the point cloud data (i.e., a sequential interpolation convolution processing process), the convolution parameters corresponding to each discrete convolution processing gradually increase. In the process of performing interpolation processing and discrete convolution processing on the point cloud data by use of different weight vectors of the discrete convolution kernel and different convolution parameters (i.e., a concurrent interpolation convolution processing process), the convolution parameters corresponding to different discrete convolution processing may be different.

Furthermore, as shown in FIG. 4, three pieces of N/4*256 data obtained by the second point cloud processing block are integrated. Specifically, channel number addition is performed on the three pieces of N/4*256 to obtain 768-channel data, recorded as N/4*768. Interpolation convolution processing is performed on N/4*768 through the 1*1*1 interpolation convolution layers to obtain 1,024-channel data, recorded as N/4*1,024. Max pooling processing is performed on N/4*1,024 based on a max pooling (Maxpooling) layer to obtain data representing a global feature vector, recorded as 1*1,024. 1*1,024 is processed based on a fully connected layer (FC) to obtain 40-channel data, recorded as 1*40, each channel corresponding to a dimension, namely 40-dimensional data is output, each dimension corresponding to a category.

In an optional embodiment of the disclosure, the method further includes operation 205. In operation 205, a category of an object in the target scene is determined based on the spatial structure feature of the point cloud data.

In the embodiment, the category of the object corresponding to the point cloud data is determined based on output multidimensional data representing the spatial structure feature of the cloud point data, namely the category of the object in the target scene is determined. Specifically, the category of the object is determined based on data of a numerically largest dimension in the multidimensional data. For example, in the example shown in FIG. 4, the 40-dimensional data is output, and the data of each dimension may correspond to a category. In such case, the data of a numerically largest dimension in the 40-dimensional data is determined, and the category corresponding to the data of the numerically largest dimension is determined as the category of the object.

With adoption of the technical solution of the embodiment of the disclosure, on one hand, interpolation processing is performed on the point cloud data to obtain the weight data configured to establish an association between the point cloud data and the first discrete convolution kernel, namely obtaining the weights of allocation of the point cloud data to the positions corresponding to the weight vectors of the first discrete convolution kernel, thereby aligning the discrete point cloud data and the weight vectors of the discrete convolution kernel to capture the spatial structure feature of the point cloud data better in the discrete convolution processing process. On the other hand, discrete convolution processing is performed on the point cloud data through different convolution parameters respectively to acquire the fine surface spatial structure feature of the point cloud data and the spatial structure feature of the background information, so that the classification accuracy of the object corresponding to the point cloud data may be improved.

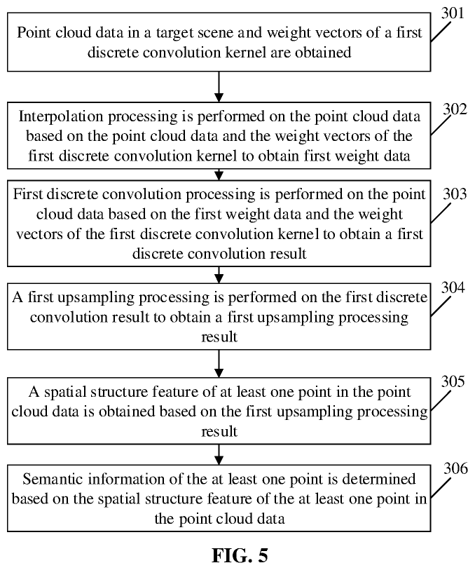

The embodiments of the disclosure also provide a method for processing point cloud data. FIG. 5 is a third flowchart of a method for processing point cloud data according to an embodiment of the disclosure. As shown in FIG. 5, the method includes the following operations.

In operation 301, point cloud data in a target scene and weight vectors of a first discrete convolution kernel are obtained.

In operation 302, interpolation processing is performed on the point cloud data based on the point cloud data and the weight vectors of the first discrete convolution kernel to obtain first weight data, the first weight data representing weights of allocation of the point cloud data to positions corresponding to the weight vectors of the first discrete convolution kernel.

In operation 303, first discrete convolution processing is performed on the point cloud data based on the first weight data and the weight vectors of the first discrete convolution kernel to obtain a first discrete convolution result.

In operation 304, a first upsampling processing is performed on the first discrete convolution result to obtain a first upsampling processing result.

In operation 305, a spatial structure feature of at least one point in the point cloud data is obtained based on the first upsampling processing result.

In the embodiment, detailed descriptions about operations 301 to 302 may specifically refer to the detailed descriptions about operations 101 to 102 in the abovementioned embodiment, and elaborations are omitted herein. Similarly, detailed descriptions about interpolation processing and discrete convolution processing in each operation of the embodiment may specifically refer to the detailed descriptions about operations 102 to 103 in the abovementioned embodiment, and elaborations are omitted herein.

In the embodiment, for extracting the spatial structure feature of the at least one point in the point cloud data to facilitate subsequent determination of semantic information of the at least one point based on the spatial structure feature of the at least one point, in the embodiment, after first discrete convolution processing is performed on the point cloud data, a size is reduced in a discrete convolution processing process, so that it is necessary to perform a first upsampling processing on the first discrete convolution result to recover the size of the first discrete convolution result, namely enlarging the size of the first discrete convolution result, to obtain the first upsampling processing result, and the spatial structure feature of the at least one point in the point cloud data is obtained based on the first upsampling processing result. During a practical application, a structure corresponding to interpolation processing and discrete convolution processing may be called a coder structure, and a structure corresponding to upsampling processing may be called a decoder structure.

In the implementation mode, interpolation processing, discrete convolution processing and upsampling processing are performed on the point cloud data once. In another implementation mode, interpolation processing, discrete convolution processing and upsampling processing may be sequentially performed for many times to recognize the spatial structure feature of the at least one point in the point cloud data better.

In an optional embodiment of the disclosure, the operation that the spatial structure feature of the at least one point in the point cloud data is obtained based on the first upsampling processing result includes that: interpolation processing is performed on a previous upsampling processing result based on the previous upsampling processing result and weight vectors of a third discrete convolution kernel to obtain third weight data, the third weight data representing weights of allocation of the previous upsampling processing result to positions corresponding to the weight vectors of the third discrete convolution kernel, where the previous upsampling processing result is the first upsampling processing result in the case of previous upsampling processing being the first upsampling processing performed on the first discrete convolution result; third discrete convolution processing is performed on the previous upsampling processing result based on the third weight data and the weight vectors of the third discrete convolution kernel to obtain a third discrete convolution result; a second upsampling processing is performed on the third discrete convolution result to obtain a second upsampling processing result; and the spatial structure feature of the at least one point in the point cloud data is obtained based on the second upsampling processing result.

It can be understood that, after interpolation processing, the first discrete convolution processing and the first upsampling processing are performed on the point cloud data once, interpolation processing, second discrete convolution processing and second upsampling processing may be repeatedly performed, and a repeat count may be pre-configured according to a practical condition.

Detailed descriptions will be made below in combination with a specific network structure.

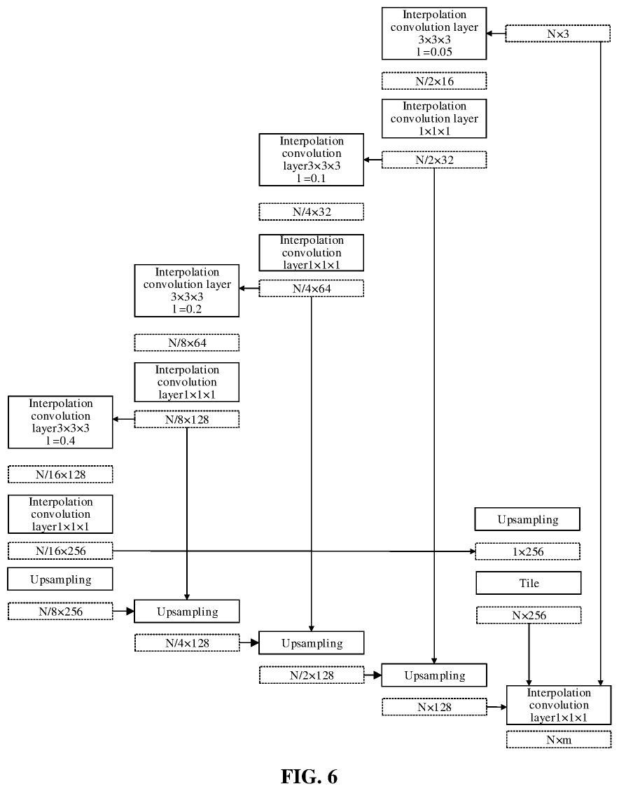

FIG. 6 is a structure diagram of a second network in a method for processing point cloud data according to an embodiment of the disclosure. As shown in FIG. 6, a coder and a decoder are included. The coder includes multiple interpolation convolution layers (InterpConv), interpolation processing and discrete convolution processing are sequentially performed on the point cloud data through the multiple interpolation convolution layers, and each interpolation convolution layer may execute the interpolation and discrete convolution processing process in the embodiment. The multiple interpolation convolution layers may correspond to different convolution parameters. As an example, the convolution parameters corresponding to the multiple interpolation convolution layers respectively may gradually increase. For example, as shown in FIG. 6, the convolution parameter corresponding to a first 3*3*3 interpolation convolution layer is 1=0.05, the convolution parameter corresponding to a second 3*3*3 interpolation convolution layer is 1=0.2, the convolution parameter corresponding to a third 3*3*3 interpolation convolution layer is 1=0.2, and the convolution parameter corresponding to a fourth 3*3*3 interpolation convolution layer is 1=0.4. In the example, the convolution parameter 1 represents a kernel length. As an example, the double of the kernel length (kernel length*2) is a side length of a cube formed by eight weight vectors in FIG. 2.

In the example, the input point cloud data is represented by an N*3 matrix vector. Data obtained after interpolation convolution processing is performed on the point cloud data through the first 3*3*3 interpolation convolution layer is 16-channel data subsampled to ½ of the original data, recorded as N/2*16. The 16-channel data (i.e., N/2*16) subsampled to ½ of the original data is input to a 1*1*1 interpolation convolution layer to obtain data of which the channel number is regulated to 32 channels, recorded as N/2*32. It can be understood that, in each embodiment of the disclosure, the 1*1*1 interpolation convolution layer is configured to regulate the channel number. The data N/2*32 is input to the second 3*3*3 interpolation convolution layer, and interpolation convolution processing is performed to obtain 32-channel data subsampled to ¼ of the original data, recorded as N/4*32. The data N/4*32 is input to the 1*1*1 interpolation convolution layer, and interpolation convolution processing is performed to obtain data of which the channel number is regulated to 64 channels, recorded as N/4*64. The data N/4*64 is input to the third 3*3*3 interpolation convolution layer, and interpolation convolution processing is performed, and obtained data is 32-channel data subsampled to ⅛ of the original data, recorded as N/8*64. The data N/8*64 is input to the 1*1*1 interpolation convolution layer, and interpolation convolution processing is performed to obtain data of which the channel number is regulated to 128 channels, recorded as N/8*128. The data N/8*128 is input to the fourth 3*3*3 interpolation convolution layer, and interpolation convolution processing is performed, and obtained data is 128-channel data subsampled to 1/16 of the original data, recorded as N/16*128. The data N/16*128 is input to the 1*1*1 interpolation convolution layer, and interpolation convolution processing is performed to obtain data of which the channel number is regulated to 256 channels, recorded as N/16*256. The above may be a processing process of the coder structure of the network.

Furthermore, upsampling processing is performed on the data N/16*256, and obtained data is 256-channel data upsampled to ⅛ of the original data, recorded as N/8*256. Upsampling processing is performed on the data N/8*256, and obtained data is 128-channel data upsampled to ¼ of the original data, recorded as N/4*128. Upsampling processing is performed on the data N/4*128, and obtained data is 128-channel data upsampled to ½ of the original data, recorded as N/2*128. Upsampling processing is performed on the data N/2*128, and obtained data is 128-channel data upsampled to the original data, recorded as N*128. The data N*128 is input to the 1*1*1 interpolation convolution layer, and interpolation convolution processing is performed to obtain N*m data, m representing the number of point clouds in the point cloud data, namely multidimensional feature data corresponding to each point cloud is obtained.

In an optional embodiment of the disclosure, the method further includes the following operation. In operation 306, semantic information of the at least one point is determined based on the spatial structure feature of the at least one point in the point cloud data.

In the embodiment, the semantic information of the at least one point is determined based on the output multidimensional data representing the spatial structure feature of the at least one point, namely a category of the at least one point is determined. The category of the point data represents object information of the point data. For example, if the target scene includes multiple objects such as a person and a vehicle, whether the object corresponding to the point data in the point cloud data is the person or the vehicle may be determined by recognition based on the semantic information of the point data, and all point data corresponding to the person and all point data corresponding to the vehicle may be determined by recognition based on the semantic information of the point data. Specifically, the data of a numerically largest dimension in the multidimensional feature data corresponding to each point in the at least one point is determined as the semantic information of the point data. For example, in the example shown in FIG. 6, N-dimensional data is output for each point, and the data of each dimension may correspond to a category. In such case, the data of a numerically largest dimension in the N-dimensional data is determined, and the category corresponding to the data of the numerically largest dimension is determined as the semantic information of the point data.

With adoption of the technical solution of the embodiment of the disclosure, interpolation processing is performed on the point cloud data to obtain the weight data configured to establish an association between the point cloud data and the first discrete convolution kernel, namely obtaining the weights of allocation of the point cloud data to the positions corresponding to the weight vectors of the first discrete convolution kernel, thereby aligning the discrete point cloud data and the weight vectors of the discrete convolution kernel to capture the spatial structure feature of the point cloud data better in the discrete convolution processing process to further acquire the semantic information of the cloud point data better.

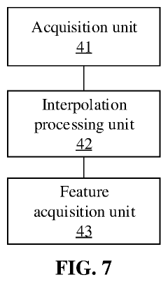

The embodiments of the disclosure also provide a device for processing point cloud data. FIG. 7 is a first composition structure diagram of a device for processing point cloud data according to an embodiment of the disclosure. As shown in FIG. 7, the device includes an acquisition unit 41, an interpolation processing unit 42 and a feature acquisition unit 43.

The acquisition unit 41 is configured to obtain point cloud data in a target scene and weight vectors of a first discrete convolution kernel.

The interpolation processing unit 42 is configured to perform interpolation processing on the point cloud data based on the point cloud data and the weight vectors of the first discrete convolution kernel to obtain first weight data, the first weight data representing weights of allocation of the point cloud data to positions corresponding to the weight vectors of the first discrete convolution kernel.

The feature acquisition unit 43 is configured to perform first discrete convolution processing on the point cloud data based on the first weight data and the weight vectors of the first discrete convolution kernel to obtain a first discrete convolution result and obtain a spatial structure feature of at least part of point cloud data in the point cloud data based on the first discrete convolution result.

In the embodiment, optionally, the interpolation processing unit 42 is configured to obtain the first weight data through a preset interpolation processing manner based on the point cloud data and the weight vectors of the first discrete convolution kernel, the first weight data representing the weights of allocation of the point cloud data to the positions corresponding to the weight vectors of the first discrete convolution kernel that meet a preset condition, where the point cloud data is in a specific geometrically shaped region enclosed by the weight vectors of the first discrete convolution kernel that meet the preset condition.

According to some embodiments, the feature acquisition unit 43 is further configured to perform first discrete convolution processing on the point cloud data based on the first weight data and the weight vectors of the first discrete convolution kernel to obtain the first discrete convolution result, perform normalization processing on the first discrete convolution result based on a normalization parameter, the normalization parameter being determined according to an amount of the point cloud data in the specific geometrically shaped region where the point cloud data is located, and obtain the spatial structure feature of at least part of point cloud data in the point cloud data based on a normalization processing result.

As an implementation mode, there are n groups of weight vectors of the first discrete convolution kernel and n groups of first weight data, where n is an integer more than or equal to 2. The feature acquisition unit 43 is configured to: perform kth first discrete convolution processing on the kth group of weight vectors of the first discrete convolution kernel and the point cloud data based on the kth group of first weight data and a kth group of first convolution parameters to obtain a kth first discrete convolution result, the kth group of first convolution parameters corresponding to a size range of kth discrete convolution processing where k is an integer more than or equal to 1 and less than or equal to n; and determine the spatial structure feature of the point cloud data based on n first discrete convolution results.

In an optional embodiment of the disclosure, the interpolation processing unit 42 is further configured to perform interpolation processing on first processing data based on the first processing data and weight vectors of a second discrete convolution kernel to obtain second weight data, the second weight data representing weights of allocation of the first processing data to positions corresponding to the weight vectors of the second discrete convolution kernel, the first processing data being determined according to a previous discrete convolution processing result and the first processing data being determined according to the n first discrete convolution results in the case of the previous discrete convolution processing result comprising the n first discrete convolution results.

The feature acquisition unit 43 is further configured to perform second discrete convolution processing on the first processing data based on the second weight data and the weight vectors of the second discrete convolution kernel to obtain a second discrete convolution result and obtain the spatial structure feature of the point cloud data based on the second discrete convolution result.

According to some embodiments, there are l groups of weight vectors of the second discrete convolution kernel and l groups of second weight data, where l is an integer more than or equal to 2. The feature acquisition unit 43 is configured to perform mth second discrete convolution processing on the mth group of weight vectors of the second discrete convolution kernel and the first processing data based on the mth group of second weight data and an mth group of second convolution parameters to obtain an mth second discrete convolution result, the mth group of second convolution parameters corresponding to a size range of mth discrete convolution processing, where m is an integer more than or equal to 1 and less than or equal to 1; and the feature acquisition unit 43 is further configured to determine the spatial structure feature of the point cloud data based on l second discrete convolution results.

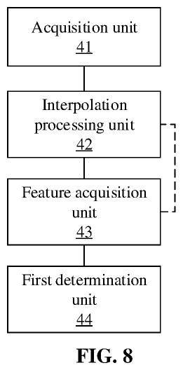

In an optional embodiment of the disclosure, as shown in FIG. 8, the device further includes a first determination unit 44, configured to determine a category of an object in the target scene based on the spatial structure feature of the point cloud data.

As another implementation mode, the feature acquisition unit 43 is configured to perform first discrete convolution processing on the point cloud data based on the first weight data and the weight vectors of the first discrete convolution kernel to obtain the first discrete convolution result, perform a first upsampling processing on the first discrete convolution result to obtain a first upsampling processing result and obtain a spatial structure feature of at least one point in the point cloud data based on the first upsampling processing result.

In another optional embodiment of the disclosure, optionally, the interpolation processing unit 42 is further configured to perform interpolation processing on a previous upsampling processing result based on the previous upsampling processing result and weight vectors of a third discrete convolution kernel to obtain third weight data, the third weight data representing weights of allocation of the previous upsampling processing result to positions corresponding to the weight vectors of the third discrete convolution kernel, where the previous upsampling processing result is the first upsampling processing result in the case of previous upsampling processing being the first upsampling processing performed on the first discrete convolution result.

The feature acquisition unit 43 is further configured to perform third discrete convolution processing on the previous upsampling processing result based on the third weight data and the weight vectors of the third discrete convolution kernel to obtain a third discrete convolution result, perform a second upsampling processing on the third discrete convolution result to obtain a second upsampling processing result and obtain the spatial structure feature of the at least one point in the point cloud data based on the second upsampling processing result.

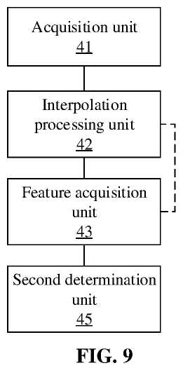

In an optional embodiment of the disclosure, as shown in FIG. 9, the device further includes a second determination unit 45, configured to determine semantic information of the at least one point based on the spatial structure feature of the at least one point in the point cloud data.

In the embodiment of the disclosure, all the acquisition unit 41, interpolation processing unit 42, feature acquisition unit 43, first determination unit 44 and second determination unit 45 in the device may be implemented by a Central Processing Unit (CPU), a Digital Signal Processor (DSP), Microcontroller Unit (MCU) or Field-Programmable Gate Array (FPGA) during a practical application.

It is to be noted that the device for processing point cloud data provided in the embodiment is described with division of each of the abovementioned program modules as an example during point cloud data processing, and during the practical application, such processing may be allocated to different program modules for completion according to a requirement, that is, an internal structure of the device is divided into different program modules to complete all or part of abovementioned processing. In addition, the device for processing point cloud data provided in the embodiment belongs to the same concept of the embodiment of the method for processing point cloud data and details about a specific implementation process thereof refer to the method embodiment and will not be elaborated herein.

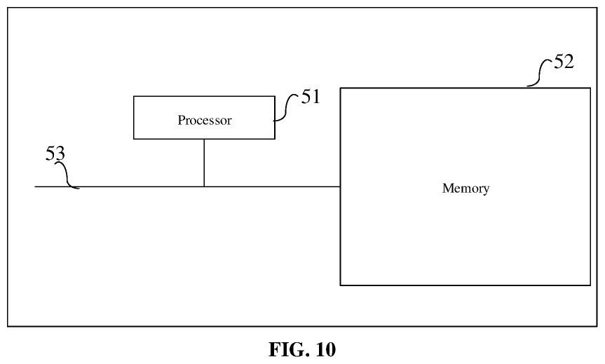

The embodiments of the disclosure also provide an electronic device. FIG. 10 is a composition structure diagram of an electronic device according to an embodiment of the disclosure. As shown in FIG. 10, a memory 52, a processor 51 and a computer program stored in the memory 52 and capable of running in the processor 51 are included, the processor 51 executing the program to implement the operations of the method for processing point cloud data of the embodiments of the disclosure.

According to some embodiments, each component in the electronic device may be coupled together through a bus system 53. It can be understood that the bus system 53 is configured to implement connection communication between these components. The bus system 53 includes a data bus and further includes a power bus, a control bus and a state signal bus. However, for clear description, various buses in FIG. 10 are marked as the bus system 53.

It can be understood that the memory 52 may be a volatile memory or a nonvolatile memory, and may also include both the volatile and nonvolatile memories. The nonvolatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, a compact disc or a Compact Disc Read-Only Memory (CD-ROM). The magnetic surface memory may be a disk memory or a tape memory. The volatile memory may be a Random Access Memory (RAM), and is used as an external high-speed cache. It is exemplarily but unlimitedly described that RAMs in various forms may be adopted, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM) and a Direct Rambus Random Access Memory (DRRAM). The memory 52 described in the embodiment of the disclosure is intended to include, but not limited to, memories of these and any other proper types.

The method disclosed in the embodiments of the disclosure may be applied to the processor 51 or implemented by the processor 51. The processor 51 may be an integrated circuit chip with a signal processing capability. In an implementation process, each operation of the method may be completed by an integrated logic circuit of hardware in the processor 51 or an instruction in a software form. The processor 51 may be a universal processor, a DSP or another Programmable Logic Device (PLD), a discrete gate or transistor logic device, a discrete hardware component and the like. The processor 51 may implement or execute each method, operation and logical block diagram disclosed in the embodiments of the disclosure. The universal processor may be a microprocessor, any conventional processor or the like. The operations of the method disclosed in combination with the embodiments of the disclosure may be directly embodied to be executed and completed by a hardware decoding processor or executed and completed by a combination of hardware and software modules in the decoding processor. The software module may be located in a storage medium, and the storage medium is located in the memory 52. The processor 51 reads information in the memory 52 and completes the operations of the method in combination with hardware.

In an exemplary embodiment, the electronic device may be implemented by one or more Application Specific Integrated Circuits (ASICs), DSPs, PLDs, Complex Programmable Logic Devices (CPLDs), FPGAs, universal processors, controllers, MCUs, microprocessors or other electronic components, and is configured to execute the abovementioned method.

In an exemplary embodiment, the embodiment of the disclosure also provides a computer storage medium, for example, a memory 52 including a computer program. The computer program may be executed by a processor 51 of an electronic device to implement the operations of the method. The computer storage medium may be a memory such as an FRAM, a ROM, a PROM, an EPROM, an EEPROM, a flash memory, a magnetic surface memory, a compact disc or a CD-ROM, and may also any device including one or any combination of the memories.

The embodiments of the disclosure provide a computer storage medium, in which a computer instruction is stored, the instruction being executed by a processor to implement the method for processing point cloud data of the embodiments of the disclosure.

The embodiments of the disclosure also provide a computer program product, which includes a computer-executable instruction, the computer-executable instruction being executed to implement any method for processing point cloud data provided in the embodiments of the disclosure.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a processing unit, each unit may also serve as an independent unit and two or more than two units may also be integrated into a unit. The integrated unit may be implemented in a hardware form and may also be implemented in form of hardware and software functional unit.

Those of ordinary skill in the art should know that all or part of the operations of the method embodiment may be implemented by related hardware instructed through a program, the program may be stored in a computer-readable storage medium, and the program is executed to execute the operations of the method embodiment. The storage medium includes: various media capable of storing program codes such as a mobile storage device, a ROM, a RAM, a magnetic disk or a compact disc.

Or, when being implemented in form of software functional module and sold or used as an independent product, the integrated unit of the disclosure may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a personal computer, a server, a network device or the like) to execute all or part of the method in each embodiment of the disclosure. The storage medium includes: various media capable of storing program codes such as a mobile hard disk, a ROM, a RAM, a magnetic disk or a compact disc.

The methods disclosed in some method embodiments provided in the disclosure may be freely combined without conflicts to obtain new method embodiments. The characteristics disclosed in some product embodiments provided in the disclosure may be freely combined without conflicts to obtain new product embodiments. The characteristics disclosed in some method or device embodiments provided in the disclosure may be freely combined without conflicts to obtain new method embodiments or device embodiments.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for processing point cloud data, comprising:
obtaining point cloud data in a target scene and weight vectors of a first discrete convolution kernel;
performing interpolation processing on the point cloud data based on the point cloud data and the weight vectors of the first discrete convolution kernel to obtain first weight data, the first weight data representing weights of allocation of the point cloud data to positions corresponding to the weight vectors of the first discrete convolution kernel;
performing first discrete convolution processing on the point cloud data based on the first weight data and the weight vectors of the first discrete convolution kernel to obtain a first discrete convolution result; and
obtaining a spatial structure feature of at least part of point cloud data in the point cloud data based on the first discrete convolution result.

2. The method of claim 1, wherein performing the interpolation processing on the point cloud data based on the point cloud data and the weight vectors of the first discrete convolution kernel to obtain the first weight data comprises:
obtaining the first weight data through a preset interpolation processing manner based on the point cloud data and the weight vectors of the first discrete convolution kernel, the first weight data representing the weights of allocation of the point cloud data to the positions corresponding to the weight vectors of the first discrete convolution kernel that meet a preset condition, wherein the point cloud data is in a specific geometrically shaped region enclosed by the weight vectors of the first discrete convolution kernel that meet the preset condition.

3. The method of claim 2, after obtaining the first discrete convolution result, further comprising: performing normalization processing on the first discrete convolution result based on a normalization parameter, the normalization parameter being determined according to an amount of the point cloud data in the specific geometrically shaped region where the point cloud data is located,
wherein obtaining the spatial structure feature of at least part of point cloud data in the point cloud data based on the first discrete convolution result comprises: obtaining the spatial structure feature of at least part of point cloud data in the point cloud data based on a normalization processing result.

4. The method of claim 1, wherein the weight vectors of the first discrete convolution kernel comprise n groups of weight vectors, and the first weight data comprises n groups of first weight data, where n is an integer more than or equal to 2,
wherein performing the first discrete convolution processing on the point cloud data based on the first weight data and the weight vectors of the first discrete convolution kernel to obtain the first discrete convolution result comprises: performing kth first discrete convolution processing on a kth group of weight vectors of the first discrete convolution kernel and the point cloud data based on a kth group of first weight data and a kth group of first convolution parameters to obtain a kth first discrete convolution result, the kth group of first convolution parameters corresponding to a size range of the kth first discrete convolution processing, where k is an integer more than or equal to 1 and less than or equal to n; and
wherein obtaining the spatial structure feature of at least part of point cloud data in the point cloud data based on the first discrete convolution result comprises: determining the spatial structure feature of the point cloud data based on n first discrete convolution results.

5. The method of claim 4, wherein determining the spatial structure feature of the point cloud data based on the n first discrete convolution results comprises:
performing interpolation processing on first processing data based on the first processing data and weight vectors of a second discrete convolution kernel to obtain second weight data, the second weight data representing weights of allocation of the first processing data to positions corresponding to the weight vectors of the second discrete convolution kernel, wherein the first processing data is determined according to a previous discrete convolution processing result, and the first processing data is determined according to the n first discrete convolution results in the case of the previous discrete convolution processing result comprising the n first discrete convolution results;
performing second discrete convolution processing on the first processing data based on the second weight data and the weight vectors of the second discrete convolution kernel to obtain a second discrete convolution result; and
obtaining the spatial structure feature of the point cloud data based on the second discrete convolution result.

6. The method of claim 5, wherein the weight vectors of the second discrete convolution kernel comprise l groups of weight vectors, and the second weight data comprise l groups of second weight data, where l is an integer more than or equal to 2,
wherein performing the second discrete convolution processing on the first processing data based on the second weight data and the weight vectors of the second discrete convolution kernel comprises: performing mth second discrete convolution processing on an mth group of weight vectors of the second discrete convolution kernel and the first processing data based on an mth group of second weight data and an mth group of second convolution parameters to obtain an mth second discrete convolution result, the mth group of second convolution parameters corresponding to a size range of the mth second discrete convolution processing, where m is an integer more than or equal to 1 and less than or equal to l; and
wherein obtaining the spatial structure feature of the point cloud data based on the second discrete convolution result comprises:
determining the spatial structure feature of the point cloud data based on l second discrete convolution results.

7. The method of claim 1, further comprising:
determining a category of an object in the target scene based on the spatial structure feature of the point cloud data.

8. The method of claim 1, wherein obtaining the spatial structure feature of at least part of point cloud data in the point cloud data based on the first discrete convolution result comprises:
performing a first upsampling processing on the first discrete convolution result to obtain a first upsampling processing result; and
obtaining a spatial structure feature of at least one point in the point cloud data based on the first upsampling processing result.

9. The method of claim 8, wherein obtaining the spatial structure feature of at least one point in the point cloud data based on the first upsampling processing result comprises:
performing interpolation processing on a previous upsampling processing result based on the previous upsampling processing result and weight vectors of a third discrete convolution kernel to obtain third weight data, the third weight data representing weights of allocation of the previous upsampling processing result to positions corresponding to the weight vectors of the third discrete convolution kernel, wherein the previous upsampling processing result is the first upsampling processing result in the case of the previous upsampling processing being the first upsampling processing performed on the first discrete convolution result;
performing third discrete convolution processing on the previous upsampling processing result based on the third weight data and the weight vectors of the third discrete convolution kernel to obtain a third discrete convolution result;
performing a second upsampling processing on the third discrete convolution result to obtain a second upsampling processing result; and
obtaining the spatial structure feature of the at least one point in the point cloud data based on the second upsampling processing result.

10. The method of claim 1, further comprising:
determining semantic information of at least one point based on the spatial structure feature of the at least one point in the point cloud data.

11. A device for processing point cloud data, comprising:
a memory storing processor-executable instructions; and
a processor configured to execute the stored processor-executable instructions to perform operations of:
obtaining point cloud data in a target scene and weight vectors of a first discrete convolution kernel;
performing interpolation processing on the point cloud data based on the point cloud data and the weight vectors of the first discrete convolution kernel to obtain first weight data, the first weight data representing weights of allocation of the point cloud data to positions corresponding to the weight vectors of the first discrete convolution kernel; and
performing first discrete convolution processing on the point cloud data based on the first weight data and the weight vectors of the first discrete convolution kernel to obtain a first discrete convolution result and obtain a spatial structure feature of at least part of point cloud data in the point cloud data based on the first discrete convolution result.

12. The device of claim 11, wherein performing the interpolation processing on the point cloud data based on the point cloud data and the weight vectors of the first discrete convolution kernel to obtain the first weight data comprises:
obtaining the first weight data through a preset interpolation processing manner based on the point cloud data and the weight vectors of the first discrete convolution kernel, the first weight data representing the weights of allocation of the point cloud data to the positions corresponding to the weight vectors of the first discrete convolution kernel that meet a preset condition, wherein the point cloud data is in a specific geometrically shaped region enclosed by the weight vectors of the first discrete convolution kernel that meet the preset condition.

13. The device of claim 12, wherein he processor is configured to execute the stored processor-executable instructions to perform an operation of: after obtaining the first discrete convolution result,
performing normalization processing on the first discrete convolution result based on a normalization parameter, the normalization parameter being determined according to an amount of the point cloud data in the specific geometrically shaped region where the point cloud data is located,
wherein obtaining the spatial structure feature of at least part of point cloud data in the point cloud data based on the first discrete convolution result comprises: obtaining the spatial structure feature of at least part of point cloud data in the point cloud data based on a normalization processing result.

14. The device of claim 11, wherein there are n groups of weight vectors of the first discrete convolution kernel and n groups of first weight data, where n is an integer more than or equal to 2,
wherein performing the first discrete convolution processing on the point cloud data based on the first weight data and the weight vectors of the first discrete convolution kernel to obtain the first discrete convolution result comprises: performing kth first discrete convolution processing on a kth group of weight vectors of the first discrete convolution kernel and the point cloud data based on a kth group of first weight data and a kth group of first convolution parameters to obtain a kth first discrete convolution result, the kth group of first convolution parameters corresponding to a size range of kth first discrete convolution processing, where k is an integer more than or equal to 1 and less than or equal to n; and
wherein obtaining the spatial structure feature of at least part of point cloud data in the point cloud data based on the first discrete convolution result comprises: determining the spatial structure feature of the point cloud data based on n first discrete convolution results.

15. The device of claim 14, wherein determining the spatial structure feature of the point cloud data based on the n first discrete convolution results comprises:
performing interpolation processing on first processing data based on the first processing data and weight vectors of a second discrete convolution kernel to obtain second weight data, the second weight data representing weights of allocation of the first processing data to positions corresponding to the weight vectors of the second discrete convolution kernel, the first processing data being determined according to a previous discrete convolution processing result and the first processing data being determined according to the n first discrete convolution results in the case of the previous discrete convolution processing result comprising the n first discrete convolution results; and
performing second discrete convolution processing on the first processing data based on the second weight data and the weight vectors of the second discrete convolution kernel to obtain a second discrete convolution result; and
obtaining the spatial structure feature of the point cloud data based on the second discrete convolution result.

16. The device of claim 15, wherein there are l groups of weight vectors of the second discrete convolution kernel and l groups of second weight data, where l is an integer more than or equal to 2,
wherein performing the second discrete convolution processing on the first processing data based on the second weight data and the weight vectors of the second discrete convolution kernel comprises: performing mth second discrete convolution processing on an mth group of weight vectors of the second discrete convolution kernel and the first processing data based on an mth group of second weight data and an mth group of second convolution parameters to obtain an mth second discrete convolution result, the mth group of second convolution parameters corresponding to a size range of mth discrete convolution processing, where m is an integer more than or equal to 1 and less than or equal to 1; and
wherein obtaining the spatial structure feature of the point cloud data based on the second discrete convolution result comprises:
determining the spatial structure feature of the point cloud data based on l second discrete convolution results.

17. The device of claim 11, wherein the processor is configured to execute the stored processor-executable instructions to perform an operation of:
determining a category of an object in the target scene based on the spatial structure feature of the point cloud data.

18. The device of claim 11, wherein obtaining the spatial structure feature of at least part of point cloud data in the point cloud data based on the first discrete convolution result comprises:
performing a first upsampling processing on the first discrete convolution result to obtain a first upsampling processing result; and
obtaining a spatial structure feature of at least one point in the point cloud data based on the first upsampling processing result.

19. The device of claim 11, wherein the processor is configured to execute the stored processor-executable instructions to perform an operation of:
determining semantic information of at least one point based on the spatial structure feature of the at least one point in the point cloud data.

20. A non-transitory computer-readable storage medium having stored thereon computer-readable instructions that, when executed by a processor, cause the processor to perform a method for processing point cloud data, the method comprising:
obtaining point cloud data in a target scene and weight vectors of a first discrete convolution kernel;
performing interpolation processing on the point cloud data based on the point cloud data and the weight vectors of the first discrete convolution kernel to obtain first weight data, the first weight data representing weights of allocation of the point cloud data to positions corresponding to the weight vectors of the first discrete convolution kernel;
performing first discrete convolution processing on the point cloud data based on the first weight data and the weight vectors of the first discrete convolution kernel to obtain a first discrete convolution result; and
obtaining a spatial structure feature of at least part of point cloud data in the point cloud data based on the first discrete convolution result.
